(19) United States
(12) Patent Application Publication
(10) Pub. No.: US 2026/0369454 A1
(43) Pub. Date: Nov. 19, 2026

(54) TRANSFORMER AND DISPLAY DEVICE INCLUDING SAME

(71) Applicant: LG INNOTEK CO., LTD., Seoul (KR)

(72) Inventors: Inseong SOHN, Seoul (KR); Younghwan JUNG, Seoul (KR); Jichang RYU, Seoul (KR)

(21) Appl. No.: 19/126,136

(22) PCT Filed: Nov. 14, 2023
(86) PCT No.: PCT/KR2023/018294

§ 371 Date: Apr. 30, 2025

(30) Foreign Application Priority Data
Nov. 18, 2022 (KR) 10-2022-0155279

(51) Int. Cl. H01F 27/00; H01F 27/06; H01F 27/24; H01F 27/28; H01F 27/32; H01F 30/10

(52) U.S. Cl. CPC H01F 27/006; H01F 27/24; H01F 27/2823; H01F 27/323; H01F 27/325; H01F 30/10; H01F 27/065

(57) ABSTRACT

A transformer according to an embodiment comprises: a core unit including an upper core and a lower core; a coil unit which includes a primary coil and a secondary coil arranged to be spaced apart from the primary coil and which is at least partially arranged in the core unit; and a bobbin unit which is at least partially arranged in the core unit and which accommodates at least a part of the coil unit, wherein the primary coil has a cross sectional shape including a plurality of wires, each of the plurality of wires includes a conductor and a first insulating portion encompassing the conductor, and the coil unit further comprises a second insulating portion arranged between the plurality of wires.

### TECHNICAL FIELD

The present disclosure relates to a transformer and a display device including the same.

### BACKGROUND ART

In general, driving power is required in order to drive an electronic device, and a power supply device, such as a power supply unit (PSU), is essentially employed in order to supply driving power to the electronic device.

In particular, a display device, such as a flat panel TV, is required to be slim, and is continually being embodied in increasingly larger sizes. Accordingly, it is necessary to reduce the thickness of such a large-scale display while meeting the increased power requirements thereof.

In the power supply unit (PSU), a transformer occupies a relatively large volume compared to other elements. In order to realize a slim transformer, a method of omitting thick elements from the transformer or adjusting the number thereof is generally considered. For example, in recent years, a bobbin, around which a primary coil and a secondary coil are wound so as to be secured thereto, has been omitted from a transformer constituting a power supply unit of a flat panel display device, or a plurality of low-capacity slim transformers has been adopted.

In such a PSU, leakage inductance within a specific range (e.g., 50 μH or greater) is required for design of a resonant tank of a circuit and frequency matching. However, because a general slim transformer is structured such that a primary coil and a secondary coil are stacked vertically, both the primary coil and the secondary coil have an influence on the thickness of the transformer due to vertical stacking thereof. Therefore, there is a limitation in reducing the thickness of the transformer, and leakage inductance decreases greatly (e.g., about 3 μH). It is necessary to secure leakage inductance having a predetermined level or higher in order to implement a switched-mode operation in a circuit.

Therefore, there is a demand for a transformer capable of being further slimmed and securing sufficient leakage inductance and a flat panel display device using the same.

In the case of a slim transformer, a primary coil and a secondary coil are spaced horizontally from each other in order to meet leakage inductance value requirements. With increase in the size of a TV, power consumption inevitably increases, and accordingly, a spacing distance between coils or the size of a core may also increase. This causes implementation of additional adjustment of a leakage inductance value as well as deterioration in the efficiency of the transformer, deterioration in workability, and increase in manufacturing cost.

In particular, in the case of a large-capacity transformer for large TVs of 500 W (watts) or greater, the size of a core becomes greater than before, which may lead to variation in the thickness of the back surface of the core or damage to the core after heat treatment for formation of the core. This may cause heat generation during operation of the transformer, resulting in deterioration in the efficiency of the transformer. Further, additional adjustment of the leakage inductance value is required.

### DISCLOSURE

### Technical Problem

A technical task of the present disclosure is to provide a transformer including a coil having a uniform winding form.

Another technical task of the present disclosure is to provide a display device to which the above transformer is applied.

The technical tasks of the present disclosure are not limited to the above-mentioned technical tasks, and other technical tasks not mentioned herein will be clearly understood by those skilled in the art from the following description.

### Technical Solution

A transformer according to an embodiment may include a core unit including an upper core and a lower core, a coil unit including a primary coil and a secondary coil spaced apart from the primary coil, at least a portion of the coil unit being disposed inside the core unit, and a bobbin unit configured to accommodate at least a portion of the coil unit, at least a portion of the bobbin unit being disposed inside the core unit. The primary coil may have a cross-sectional shape including a plurality of wires, each of the plurality of wires may include a conductor and a first insulating portion surrounding the conductor, and the coil unit may further include a second insulating portion disposed between the plurality of wires.

In an example, the first insulating portion may include three stacked insulation coating layers.

In an example, the second insulating portion may include an adhesive material.

In an example, the second insulating portion may include a portion extending from a region between the plurality of wires to surround the outer periphery of the primary coil.

In an example, the variation in the minimum thickness of the second insulating portion disposed between the plurality of wires may be within 7%.

In an example, the variation in the minimum distance between adjacent wires among the plurality of wires may be within 7%.

In an example, the variation in the minimum distance may be equal to or less than the thickness of the first insulating portion.

In an example, the inner circumferential portion of the secondary coil may be disposed along the outer circumferential portion of the primary coil, and the variation in the distance between the outer circumferential portion and the inner circumferential portion in at least one of the long-axis direction or the short-axis direction of the transformer may be within 7%.

In an example, the variation may be determined according to a target leakage inductance.

In an example, the variation in the long-axis direction and the variation in the short-axis direction may be equal to each other.

In an example, the difference between the minimum thickness and the maximum thickness of the primary coil when viewed in a sectional view may be greater than the thickness of the first insulating portion and less than the radius of each of the plurality of wires.

In an example, the difference between the minimum width and the maximum width of the primary coil when viewed in a plan view may be greater than the width of the first insulating portion and less than the radius of each of the plurality of wires.

In an example, the bobbin unit may include an inner partition wall disposed between the primary coil and the secondary coil.

In an example, the bobbin unit may further include an outer partition wall defining a space for accommodation of the secondary coil together with the inner partition wall.

In an example, the bobbin unit may include first and second bobbins disposed to face each other in a second direction with the coil unit interposed therebetween and a third bobbin disposed between the first and second bobbins. The first bobbin may include a first end part having one side of the coil unit disposed thereon and a plurality of first ribs extending from the first end part toward the second bobbin and disposed parallel to each other in a third direction intersecting the second direction. The second bobbin may include a second end part having the other side of the coil unit disposed thereon, a plurality of 2-1^{st} ribs, and a plurality of 2-2^{nd} ribs extending from the second end part toward the first bobbin and overlapping the plurality of first ribs in the second direction, respectively. The third bobbin may include a seating support portion having one side of the coil unit disposed thereon, at least a portion of the seating support portion being accommodated in the first end part, and a plurality of third ribs extending from the seating support portion toward the second bobbin and overlapping the plurality of 2-1^{st} ribs in the second direction, respectively. The plurality of first ribs and the plurality of 2-2^{nd} ribs may form the outer partition wall, and the plurality of 2-1^{st} ribs and the plurality of third ribs may form the inner partition wall.

In an example, the spacing distance between the first bobbin and the second bobbin in the second direction may be uniform.

A display device according to another embodiment may include a transformer and a circuit board having the transformer disposed thereon.

Aspects of the present disclosure are only some of the preferred embodiments of the present disclosure, and various embodiments in which the technical features of the present disclosure are reflected can be derived and understood by those skilled in the art based on the detailed description of the present disclosure to be described below.

### Advantageous Effects

The present disclosure described above has the following effects.

The variation in leakage inductance may be reduced and maintained uniformly, and may also be accurately predicted and controlled. In addition, the structure of the bobbin unit may be simplified, the time and labor required to perform the winding process may be reduced, and the winding form may be maintained uniformly without being affected by external variables caused by operators or the like, thereby improving the quality of the transformer.

The effects achievable through the present disclosure are not limited to the above-mentioned effects, and other effects not mentioned herein will be clearly understood by those skilled in the art from the following description.

### DESCRIPTION OF DRAWINGS

FIG. 1 is a perspective view showing an embodiment of a transformer of the present disclosure.

FIG. 2 is an exploded perspective view of FIG. 1.

FIG. 3 is a bottom perspective view of FIG. 1.

FIG. 4 is a bottom exploded perspective view of FIG. 3.

FIG. 5A is a plan view showing a transformer including segment cores separated by the same spacing distance according to the present disclosure.

FIG. 5B is a plan view showing a transformer including segment cores separated by different spacing distances according to the present disclosure.

FIG. 5C is a plan view showing a transformer including segment cores having different sizes separated by the same spacing distance according to the present disclosure.

FIG. 5D is a plan view showing a transformer including segment cores having different sizes separated by different spacing distances according to the present disclosure.

FIG. 6 is an exploded perspective view of a bobbin unit according to the present disclosure.

FIG. 7A is a plan view showing the bobbin unit according to the present disclosure.

FIG. 7B is a cross-sectional view of portion A-A in FIG. 7A.

FIG. 7C is a cross-sectional view of portion B-B in FIG. 7A.

FIG. 7D is a cross-sectional view of portion C-C in FIG. 7A.

FIG. 8 is a perspective view showing a state in which a core unit is removed from the transformer according to the present disclosure.

FIG. 9 is a perspective view showing a state in which a first bobbin is removed from FIG. 8.

FIG. 10 is a perspective view showing a state in which a secondary coil is formed in two rows in FIG. 9.

FIG. 11 is a perspective view showing a third bobbin according to the present disclosure.

FIG. 12 is a cross-sectional view of a transformer according to a further embodiment.

FIGS. 13A to 13C show embodiments of portion “A” shown in FIG. 12.

FIG. 14 is a plan view showing an embodiment of the transformer shown in FIG. 12.

FIG. 15 is a plan view of a transformer according to a comparative example.

FIG. 16 is a cross-sectional view of the primary coil taken along line II-II′ in FIG. 15.

### BEST MODE

The present disclosure will now be described more fully hereinafter with reference to the accompanying drawings, in which various embodiments are shown. The examples, however, may be embodied in many different forms and should not be construed as being limited to the embodiments set forth herein. It is to be understood that the present disclosure covers all modifications, equivalents, and alternatives falling within the scope and spirit of the present disclosure.

While ordinal numbers including “second”, “first”, etc. may be used to describe various components, they are not intended to limit the components. These expressions are used only to distinguish one component from another component. For example, a second element could be termed a first element, and, similarly, a first element could be termed a second element, without departing from the scope of the present disclosure. As used herein, the term “and/or” includes any and all combinations of one or more of the associated listed items.

It will be understood that when an element is referred to as being “connected” or “coupled” to another element, it can be directly connected or coupled to the other element, or intervening elements may be present. In contrast, when an element is referred to as being “directly connected” or “directly coupled” to another element, there are no intervening elements present.

In the description of the embodiments, it will be understood that when an element, such as a layer (film), a region, a pattern or a structure, is referred to as being “on” or “under” another element, such as a substrate, a layer (film), a region, a pad or a pattern, the term “on” or “under” means that the element is “directly” on or under another element or is “indirectly” formed such that an intervening element may also be present. It will also be understood that criteria of on or under is on the basis of the drawing. In addition, the thickness or size of a layer (film), a region, a pattern or a structure shown in the drawings may be exaggerated, omitted or schematically drawn for the clarity and convenience of explanation, and may not accurately reflect the actual size.

The terminology used herein is for the purpose of describing particular embodiments only and is not intended to be limiting of exemplary embodiments of the disclosure. As used herein, the singular forms are intended to include the plural forms as well, unless the context clearly indicates otherwise. It will be further understood that the term “include” or “have”, when used herein, specifies the presence of stated features, integers, steps, operations, elements, components, or combinations thereof, but do not preclude the presence or addition of one or more other features, integers, steps, operations, elements, components, or combinations thereof.

Unless otherwise defined, all terms used herein, which include technical or scientific terms, have the same meanings as those generally appreciated by those skilled in the art. The terms, such as ones defined in common dictionaries, should be interpreted as having the same meanings as terms in the context of pertinent technology, and should not be interpreted as having ideal or excessively formal meanings unless clearly defined in the specification.

Hereinafter, embodiments will be described in detail with reference to the accompanying drawings, and the same or equivalent elements are denoted by the same reference numerals even when they are depicted in different drawings, and redundant descriptions thereof will be omitted. In addition, the embodiments will be described using the Cartesian coordinate system, but may also be described using other coordinate systems. In the Cartesian coordinate system, the x-axis, the y-axis, and the z-axis shown in each drawing are perpendicular to each other, but the embodiments are not limited thereto. The x-axis, the y-axis, and the z-axis may intersect each other obliquely.

In addition, considering that a transformer related to the embodiments is mounted on a circuit board of a display device, the thickness (or the vertical height) of the transformer according to the present disclosure for contributing to slimness of the display device may be 14 mm or less, more specifically 12 mm or less, and even more specifically 10 mm or less, from the upper surface of the circuit board.

Hereinafter, a transformer to which segment cores according to the embodiments are applied will be described in detail with reference to the accompanying drawings.

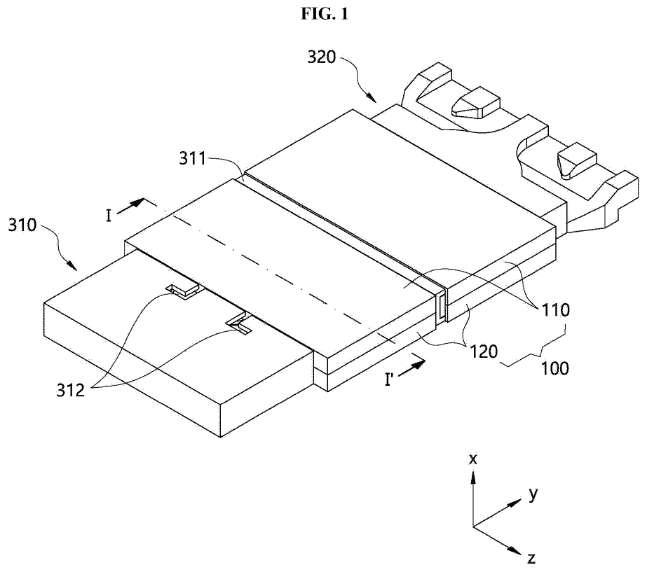

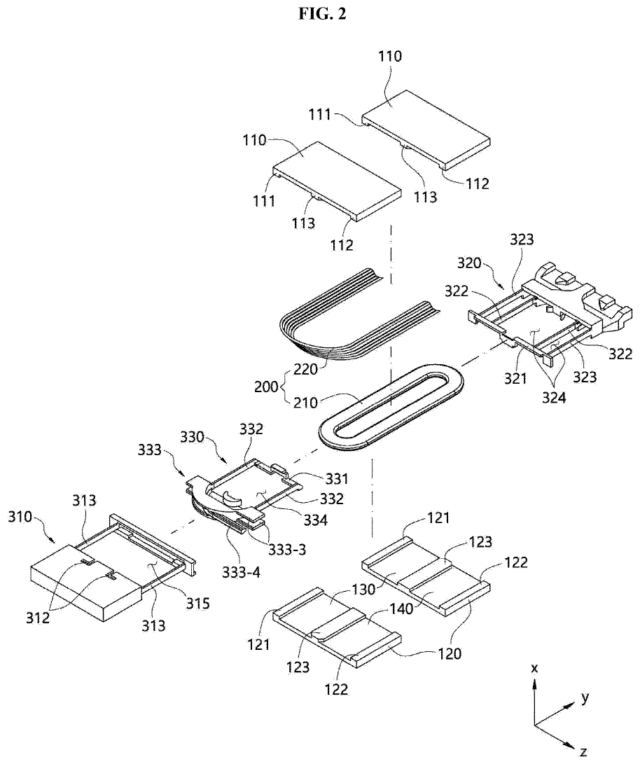

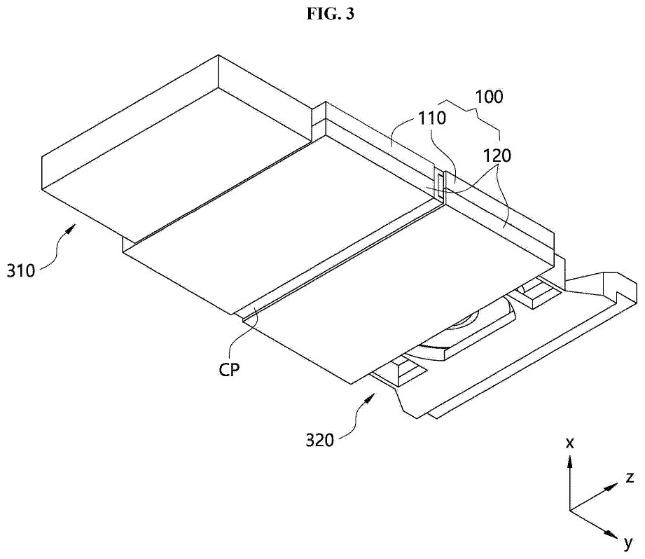

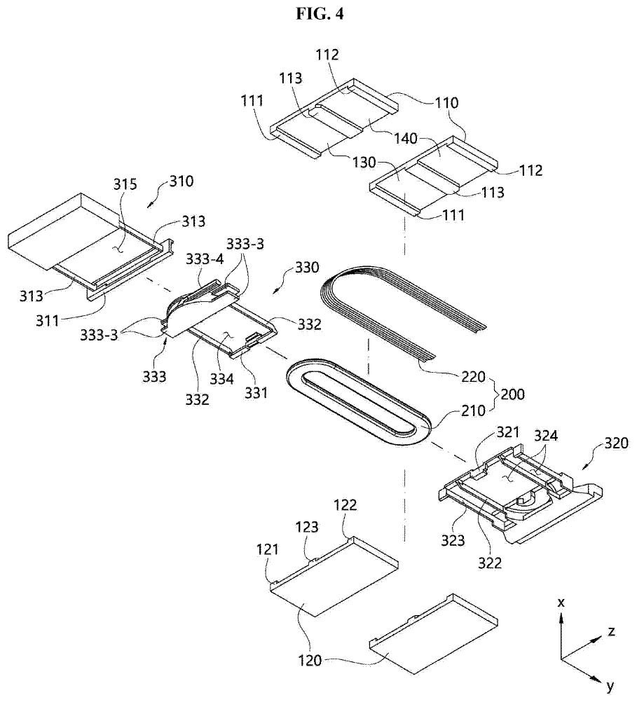

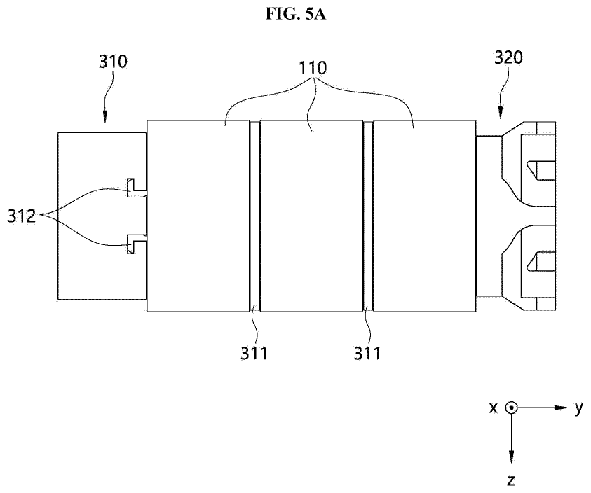

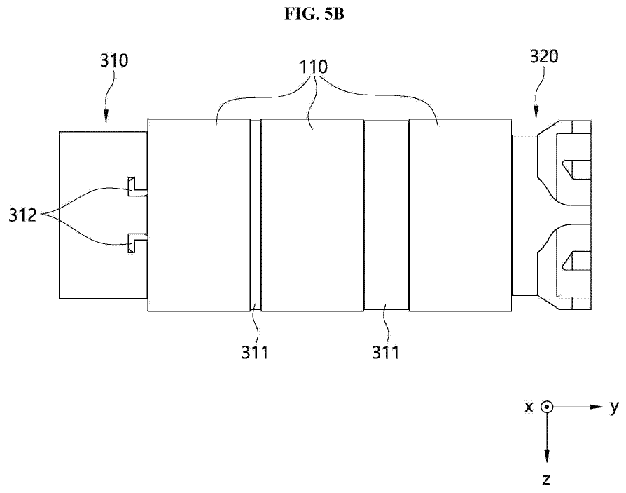

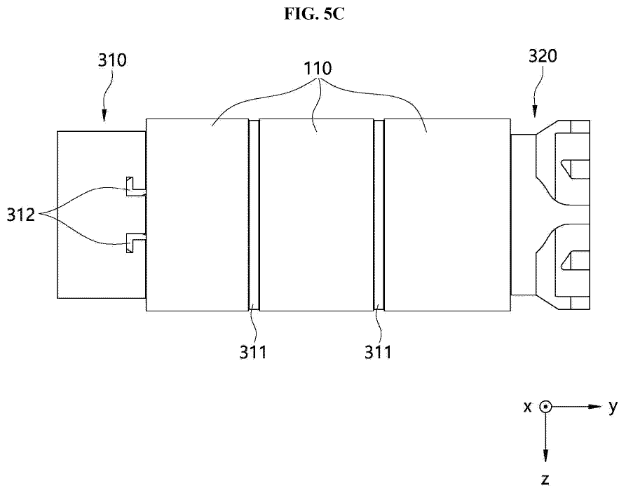

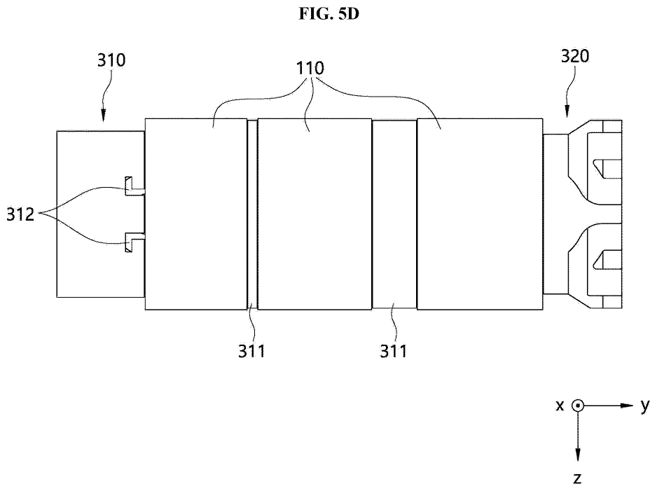

FIG. 1 is a perspective view showing an embodiment of a transformer of the present disclosure, FIG. 2 is an exploded perspective view of FIG. 1, FIG. 3 is a bottom perspective view of FIG. 1, FIG. 4 is a bottom exploded perspective view of FIG. 3, FIG. 5A is a plan view showing a transformer including segment cores separated by the same spacing distance according to the present disclosure, FIG. 5B is a plan view showing a transformer including segment cores separated by different spacing distances according to the present disclosure, FIG. 5C is a plan view showing a transformer including segment cores having different sizes separated by the same spacing distance according to the present disclosure, and FIG. 5D is a plan view showing a transformer including segment cores having different sizes separated by different spacing distances according to the present disclosure.

First, the structure of a transformer to which segment cores of the present disclosure are applied (hereinafter referred to as a “transformer”) will be described below with reference to FIGS. 1 to 5.

The transformer of the present disclosure may include a core unit 100, a coil unit 200, and a bobbin unit 300.

The core unit 100 may have the characteristics of a magnetic circuit and thus may act as a path for magnetic flux.

The core unit 100 may include an upper core 110 and a lower core 120. The upper core 110 may include a first upper core 110-1 and a second upper core 110-2, and the lower core 120 may include a first lower core 120-1 and a second lower core 120-2. In this case, the first upper core 110-1 and the first lower core 120-1 may be defined as a first core, and the second upper core 110-2 and the second lower core 120-2 may be defined as a second core. The upper core 110 and the lower core 120 may be separated from each other in a first direction (the x-axis direction), and the upper core 110 and the lower core 120 may be combined to form one core unit 100. In this case, the upper core 110 may be defined as a core located farthest from the upper surface of the circuit board in the first direction, and the lower core 120 may be defined as a core located closest to the upper surface of the circuit board in the first direction. The upper core 110 and the lower core 120 may be formed to be symmetrical or asymmetrical with each other in the vertical direction, that is, the first direction. However, for convenience of explanation, the following description will be given on the assumption that the two cores are formed to be vertically symmetrical with each other.

Each of the upper core 110 and the lower core 120 may be divided into a plurality of segment cores. That is, as shown in FIGS. 1 to 4, each of the upper core 110 and the lower core 120 may be segmented into a first core and a second core in the y-axis direction. In this case, the lengths of the first core and the second core in the y-axis direction may be the same. For example, the configuration in which the lengths of the cores in the y-axis direction are “the same” may be construed as including a configuration in which a variation between the lengths of the cores in the y-axis direction is less than 1% taking into consideration tolerance occurring during, for example, molding or processing of the cores. Thus, the lengths of the first upper core 110-1, the second upper core 110-2, the first lower core 120-1, and the second lower core 120-2 in the y-axis direction may be the same, and the allowable variation between the lengths in the y-axis direction may be less than 1%. In addition, as shown in FIGS. 5A to 5D, each of the upper core 110 and the lower core 120 may be divided into three segment cores. It is to be understood that division into more than three segment cores is also possible. Alternatively, although not shown, only the upper core 110 may be divided into a plurality of segment cores, or only the lower core 120 may be divided into a plurality of segment cores. Alternatively, the number of segment cores of the upper core 110 and the number of segment cores of the lower core 120 may be different. Alternatively, the segment cores of each of the upper core 110 and the lower core 120 may be formed to have different sizes. Alternatively, as shown in FIGS. 5A and 5B, the segmented upper cores 110 may be formed to have the same length in the y-axis direction, or as shown in FIGS. 5C and 5D, the segmented upper cores 110 may be formed to have different lengths in the y-axis direction, and the spacing distances between the segmented upper cores 110 may be the same or different.

In this case, as shown in the drawings, the core unit 100 may be segmented in a second direction (the y-axis or z-axis direction) intersecting the first direction (the x-axis direction). Hereinafter, for convenience of description, the z-axis direction will be referred to as a third direction.

Referring again to FIGS. 1 to 4, the minimum spacing distance between the segmented upper cores 110, that is, between the plurality of upper segment cores, may be in a range of 0% to 8.75% of the sum of the length of the first upper core 110-1 in the second direction and the length of the second upper core 110-2 in the second direction. For example, “0%” may indicate a configuration in which the first upper core 110-1 and the second upper core 110-2 are disposed in contact with each other in a segmented form. In addition, the configuration in which the cores are disposed in contact with each other may indicate a configuration in which the first upper core 110-1 and the second upper core 110-2 are in a segmented form rather than being integrated, and are spaced apart from each other by a minimum distance. In addition, “0%” may indicate a configuration in which a fastening part CP, which will be described later, is not disposed in the space between the first upper core 110-1 and the second upper core 110-2, that is, a configuration in which the fastening part CP is covered by the first upper core 110-1 and the second upper core 110-2 so as not to be exposed. The upper core 110 according to the present disclosure may increase the leakage inductance value by employing the segmented cores. However, if the minimum spacing distance between the plurality of upper segment cores exceeds 8.75% of the sum of the length of the first upper core 110-1 in the second direction and the length of the second upper core 110-2 in the second direction, there is no change in the leakage inductance value, but the winding length of the coil unit 200 in the second direction increases, and accordingly, a coil resistance value, that is, a direct current resistance (DCR) value, increases, which causes deterioration in the efficiency of the transformer.

Meanwhile, since the present disclosure has a structure in which the upper and lower surfaces of the bobbin unit are omitted, the rigidity of the bobbin may be increased through placement of a plurality of ribs to be described later. Therefore, when the structure of the fastening part CP formed by engaging end portions of the plurality of ribs is employed, the rigidity of the bobbin may be further increased. To this end, the length of the fastening part CP in the second direction, that is, the spacing distance between the first upper core 110-1 and the second upper core 110-2, may be set to at least 1 mm, which corresponds to 1.25% of the sum of the length of the first upper core 110-1 in the second direction and the length of the second upper core 110-2 in the second direction.

In addition, the minimum spacing distance between the segmented lower cores 120, that is, between the plurality of lower segment cores, may also be in a range of 0% to 8.75% of the sum of the length of the first lower core 120-1 in the second direction and the length of the second lower core 120-2 in the second direction. In addition, the lower core 120 has a structure opposite to that of the upper core 110 in the first direction. Thus, with regard to the minimum spacing distance between the plurality of lower segment cores, reference may be made to the above description of the minimum spacing distance between the upper segment cores.

Meanwhile, the minimum spacing distance between the segment cores of the upper core 110 or the lower core 120 may be set to, for example, 1 mm to 7 mm, and more specifically 1 mm to 5 mm. As the spacing distance between the upper core 110 and the lower core 120 increases, the leakage inductance value increases. However, if the spacing distance exceeds 5 mm, the leakage inductance value is saturated. In addition, if the spacing distance exceeds 7 mm, the coil resistance value increases due to increase in the winding length in the second direction, leading to deterioration in the efficiency of the transformer. Thus, the spacing distance may be designed up to 7 mm. However, it may be advantageous to set the spacing distance to at most 5 mm in consideration of the leakage inductance value.

In addition, a part of the bobbin unit 300, that is, the fastening part CP, may be disposed in the space between the upper core 110 and the lower core 120, and thus, the spacing distance between the upper core 110 and the lower core 120 may also be understood as the thickness of the fastening part CP. Therefore, in order to secure the rigidity of the bobbin unit 300 for support of the upper core 110 and the lower core 120, it may be advantageous to set the spacing distance between the upper core 110 and the lower core 120 to at least 1 mm. In addition, although the rigidity of the bobbin unit 300 may be secured as the spacing distance between the upper core 110 and the lower core 120 increases, if the spacing distance exceeds 5 mm, the coil resistance value may increase due to increase in the winding length in the second direction, which may deteriorate the efficiency of the transformer.

Therefore, in order to secure the leakage inductance and to secure the rigidity of the bobbin unit 300, it may be advantageous to set the spacing distance between the upper core 110 and the lower core 120 to 1 mm to 5 mm.

The transformer according to the present disclosure is adapted to finely adjust the leakage inductance. As described above, the core unit 100 is implemented as a plurality of segment cores, rather than being implemented as a single core, to adjust the leakage inductance. That is, the electrical characteristics of the transformer may be finely adjusted through the spacing distance generated between the segment cores. Further, because the upper core 110 and the lower core 120 are made to have different thicknesses (lengths in at least one of the x-axis direction, the y-axis direction, or the z-axis direction), adjustment of the leakage inductance is possible. Therefore, at least one of the segmentation direction, the segmentation interval, the number of segment cores of the core unit 100, or the thickness of the core unit 100 may be adjusted depending on the required leakage inductance value. Furthermore, because the core unit 100 is manufactured so as to be segmented, when the core unit 100 is used in a large-capacity transformer adapted for, for example, large TVs, it may be possible to control heat generation attributable to variation in the shape of the core and to improve the product yield of the core.

A part of the bobbin unit 300, that is, the fastening part CP, may be disposed between the plurality of separated segment cores. The gap between the separated segment cores may remain as an empty space. However, if the fastening part CP is disposed between the separated segment cores, it may be possible to prevent chipping or cracking of the core due to contact between the segment cores during use of the transformer. Therefore, it may be advantageous to place a part of the bobbin unit 300 between the separated segment cores, and, for example, the fastening part CP may be placed therebetween. Although not shown in the drawings, the fastening part CP may be divided into an upper fastening member and a lower fastening member. The upper fastening member may be disposed in an area formed by separation between the first upper core and the second upper core, and the lower fastening member may be disposed in an area formed by separation between the second lower core and the second lower core. In this case, if the number of segment cores of the upper core and the number of segment cores of the lower core are different from each other, only the upper fastening member may be disposed, or only the lower fastening member may be disposed. On the other hand, if the number of upper segment cores and the number of lower segment cores are identical to each other, it may be advantageous that the position of the upper fastening member and the position of the lower fastening member at least partially overlap each other in the first direction. In a further embodiment, the width of the upper fastening member in the second direction and the width of the lower fastening member in the second direction may correspond to each other and may overlap each other in the first direction.

Referring to FIGS. 2 and 4, a first outer leg portion 111 may be disposed on one side of the upper core 110 in the third direction so as to protrude downward in the first direction and to extend in the second direction. In addition, a second outer leg portion 112 may be disposed on the opposite side of the upper core 110 in the third direction so as to protrude downward in the first direction and to extend in the second direction. In addition, a center leg portion 113 may be disposed between the first outer leg portion 111 and the second leg portion 112 so as to protrude downward in the first direction and to extend in the second direction. The first outer leg portion 111, the second outer leg portion 112, and the center leg portion 113 may be disposed parallel to each other. In addition, the widths of the first outer leg portion 111, the second outer leg portion 112, and the center leg portion 113 in the z-axis direction may be identical to or different from each other. Meanwhile, a first outer leg portion 121, a second outer leg portion 122, and a center leg portion 123 may also be disposed on the lower core 120 so as to be opposite those of the upper core 110.

The core unit 100 may further include a first space 130 and a second space 140. The first space 130 may be defined between the first outer leg portions 111 and 121 and the center leg portions 113 and 123, and may accommodate a portion of each of the coil unit 200 and the bobbin unit 300, which will be described later. The second space 140 may be defined between the second outer leg portions 112 and 122 and the center leg portions 113 and 123, and may accommodate another portion of each of the coil unit 200 and the bobbin unit 300 that is disposed opposite the portion thereof in the z-axis direction, which will be described later. Therefore, the first space 130 and the second space 140 may be defined corresponding to the thicknesses of and an interval between the portion and the other portion of each of the coil unit 200 and the bobbin unit 300 accommodated therein. The inductance of the core unit 100 may be controlled through adjustment of the sizes of the first space 130 and the second space 140, and heat generation of the transformer may be controlled according to the number of first spaces 130 and the number of second spaces 140. The core unit 100 may include a magnetic material, for example, iron or ferrite, but the disclosure is not necessarily limited thereto.

The coil unit 200 may include a primary coil 210 and a secondary coil 220.

At least a portion of the primary coil 210 may be disposed in a donut shape inside the core unit 100. That is, as described above, the portion and the other portion of the primary coil 210 may be accommodated in the first space 130 and the second space 140. The primary coil 210 may secure unit withstand voltage of the transformer through employment of a triple insulated wire. When a magnetic component such as a transformer is developed, there are withstand voltages required for the developed unit component. Generally, required withstand voltage is higher than or equal to a certain multiple of the operating voltage of the corresponding component. Accordingly, in the case of a component in which a conventional UTSC wire is wound, an insulation distance for securing withstand voltage is generated in order to satisfy withstand voltage. In this case, the insulation distance to be secured is determined in accordance with the standard. For example, if the withstand voltage required for a transformer called “A”, that is, the withstand voltage between a primary coil and a secondary coil, is 4 kV or higher, the shortest distance between the primary coil and the secondary coil should be designed to be 4 mm or greater in order to satisfy the standard of the component. However, the components mentioned herein refer to components manufactured using USTC wires, PCBs, copper plates, or the like.

In contrast, according to the present disclosure, since a triple insulated wire that is electrically isolated is used, it is not necessary to comply with the aforementioned insulation distance standard. The triple insulated wire refers to a wire coated with three layers of insulation, and use of the triple insulated wire may enhance withstand voltage performance. In particular, in the case of a high-capacity transformer, it is difficult to satisfy the required component performance by using a conventional USTC wire and securing the insulation distance. Therefore, by employing the triple insulated wire, it may be possible not only to satisfy the withstand voltage specifications but also to manufacture the component in a compact form without adhering to the conventional insulation distance standard.

The primary coil 210 may employ a self-bonding wire. That is, the entirety of the plurality of primary coil windings may be coated with an insulating synthetic resin, such as epoxy. By employing the self-bonding wire in this manner, the overall strength of the winding form may be increased, with a result that the overall rigidity of the transformer may also be improved.

The secondary coil 220 may be disposed along the outer periphery of the wound primary coil 210, and the portion and the other portion thereof may be accommodated in the first space 130 and the second space 140 together with the primary coil 210. The secondary coil 220 may be formed by winding a plurality of secondary wires in a single layer or multiple layers. The secondary coil 220 may be wound in the state in which a portion thereof is flipped once, which will be described in detail later. The coil unit 200 may be wound in a donut shape on the bobbin unit 300 and may be at least partially disposed inside the core unit 100.

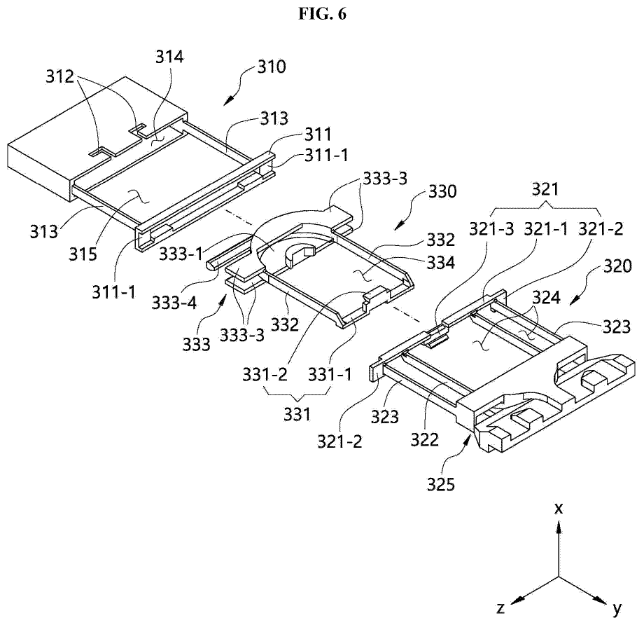

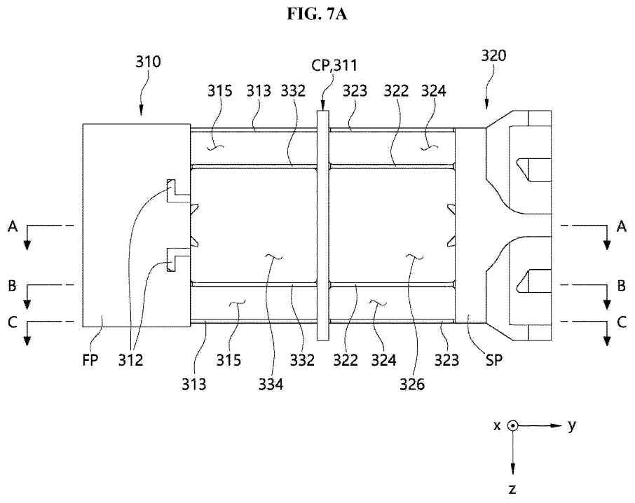

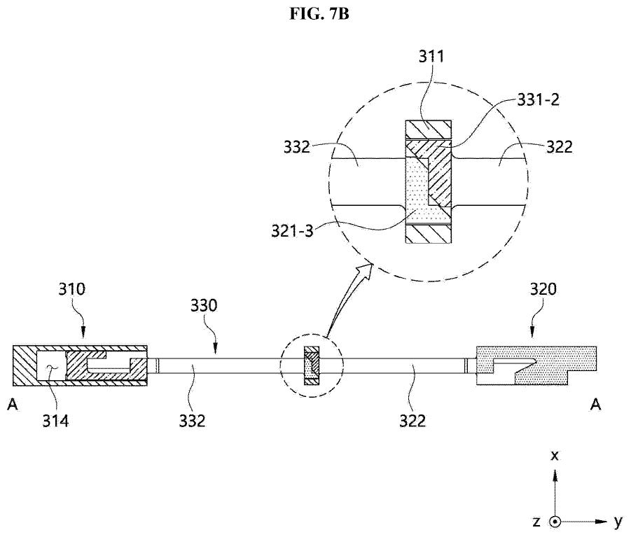

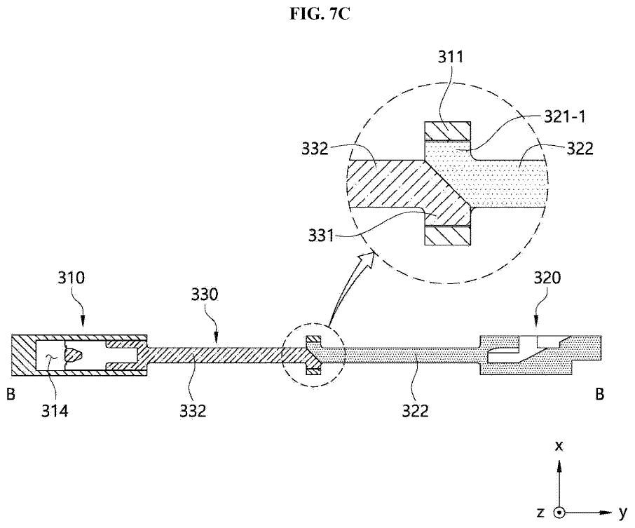

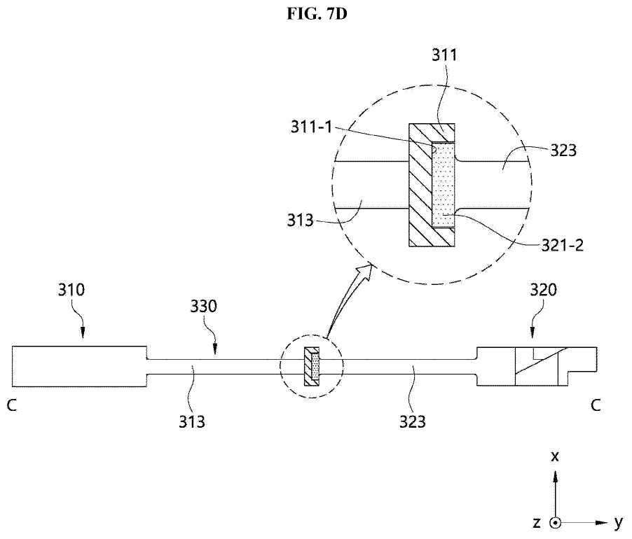

FIG. 6 is an exploded perspective view of the bobbin unit according to the present disclosure, FIG. 7A is a plan view showing the bobbin unit according to the present disclosure, FIG. 7B is a cross-sectional view of portion A-A in FIG. 7A, FIG. 7C is a cross-sectional view of portion B-B in FIG. 7A, and FIG. 7D is a cross-sectional view of portion C-C in FIG. 7A.

The bobbin unit 300 according to the present disclosure will be described with reference to FIGS. 6 and 7 (FIGS. 7A to 7D) together with FIGS. 2 and 4. For convenience of description, based on FIG. 6, the first direction will be referred to as the x-axis direction, the second direction will be referred to as the y-axis direction, the third direction will be referred to as the z-axis direction, the left-upper oblique portion in the y-axis direction will be referred to as one side or one end, and the right-lower oblique portion in the y-axis direction, opposite one side or one end, will be referred to as the other side or the other end. In addition, the portion located at an upper position in the x-axis direction will be referred to as an upper portion, an upper end, or an upper side, and the portion located at a lower position in the x-axis direction will be referred to as a lower portion, a lower end, or a lower side.

The bobbin unit 300 is a part to which the core unit 100 and the coil unit 200 are coupled. In the second direction, a first end part FP may be disposed on one side of the bobbin unit 300, a second end part SP may be disposed on the other side of the bobbin unit 300, and an intermediate part (not denoted by a reference numeral) may be disposed between the first end part FP and the second end part SP. Therefore, the remaining part, other than the first end part FP and the second end part SP, may be understood as the intermediate part. The core unit 100 may be disposed on at least a portion of the intermediate part.

The bobbin unit 300 may be provided in plural, for example, may be three in number. That is, the bobbin unit 300 may include a first bobbin 310, a second bobbin 320, and a third bobbin 330.

The first end part FP disposed on one side of the first bobbin 310 may have a rectangular parallelepiped shape and may include an inner accommodation recess 314 formed in one side thereof in the second direction. A coil lead-out portion 312 may be formed in the upper portion of the inner accommodation recess 314, that is, the upper surface of the first end part FP in the first direction. The coil lead-out portion 312 may be provided in plural, for example, may be two in number. The coil lead-out portion 312 may be formed in a recess shape extending in a direction from the other side of the upper surface of the first end part FP toward one side thereof, and an end portion of the coil lead-out portion 312 in one side direction may be bent and extend by a predetermined length in the third direction (the z-axis direction). In the case in which two coil lead-out portions 312 are formed, the two coil lead-out portions 312 may be bent and extend by a predetermined length in opposite directions in order to secure an insulation distance between the coils led out. The coil lead-out portion 312 may facilitate lead-out and fixing of the distal end of the conductive wire constituting the primary coil 210 from and to the upper portion of the first bobbin 310 in the x-axis direction. In this case, the coil lead-out portion 312 may be described interchangeably with a first terminal portion as an area in which the distal end of the conductive wire of the primary coil 210 is disposed. In addition, the distal end of the conductive wire of the primary coil 210 having passed through the coil lead-out portion 312 may be disposed at a lower position than the maximum height of the upper core 110, thereby contributing to slimness of the transformer.

Meanwhile, the coil unit 200 may also include a first end portion, a second end portion, and an intermediate portion corresponding to the bobbin unit 300, and the first end part of the coil unit 200 may be inserted into and disposed in the first end part FP of the bobbin unit 300, that is, the inner accommodation recess 314.

A first fastening member 311 may be disposed on the other side of the first bobbin 310. The first fastening member 311 may be formed in a rectangular frame shape in which two horizontal frames spaced apart from each other in the first direction and extending in the third direction and two frames connected to both end portions of each of the two horizontal frames in the first direction are coupled to each other to form a hole in the second direction. In this case, support protrusions 311-2 protruding upward may be formed on the lower portions of both inner sides of the rectangular frame. A portion of the secondary coil 220 may be seated on each of the support protrusions 311-2.

In addition, the width of the first fastening member 311 in the second direction may correspond to the width between the separated segment cores. In addition, the first fastening member 311 may include seating recesses 311-1 formed in both side portions thereof in the third direction so as to be recessed from the other side toward one side of the first fastening member in the second direction.

In addition, both sides of the inner accommodation recess 314 in the third direction and both sides of the first fastening member 311 in the third direction may be connected to each other via first ribs 313, and the vertical thickness of the first ribs 313 in the first direction may correspond to or be greater than the thickness of the coil unit 200.

The second bobbin 320 may include a second fastening member 321 formed on one side thereof and may include a coil support portion 325 into/from which the primary coil 210 and the secondary coil 220 are introduced/led out. The coil support portion 325 may be described interchangeably with a second terminal portion as an area in which the distal end of the secondary coil 220 is disposed. In this case, the other side of the primary coil 210 may be disposed below the coil support portion 325.

The second fastening member 321 may be disposed so as to be inserted into the rectangular frame of the first fastening member 311. The second fastening member 321 may include an upper frame 321-1 extending in the third direction from the upper portion in the first direction and support pieces 321-2 extending downward in the first direction from both sides of the upper frame 321-1 in the third direction. When the second fastening member 321 and the first fastening member 311 are engaged with each other, the upper frame 321-1 may be disposed on the inner upper portion of the rectangular frame, and the support pieces 321-2 may be in contact with and supported by the seating recesses 311-1.

In addition, both side portions of the coil support portion 325 in the third direction and both side portions of the second fastening member 321 in the third direction may be connected to each other via 2-2^{nd} ribs 323, and 2-1^{st} ribs 322 may be disposed so as to be spaced inward from the respective 2-2^{nd} ribs 323 by a predetermined interval in the third direction. For example, the predetermined interval may be an interval corresponding to the width of the secondary coil 220 in the third direction. The vertical thicknesses of the 2-1^{st} ribs 322 and the 2-2^{nd} ribs 323 in the first direction may also correspond to or be greater than the vertical thickness of the coil unit 200 in the first direction.

In addition, a first fastening portion 321-3 having a hook shape may be formed on the lower portion of the upper frame 321-1 so as to extend in the other side direction.

The third bobbin 330 may include a seating support portion 333 formed on one side thereof in the second direction and may include a third fastening member 331 formed on the other side thereof in the second direction. The seating support portion 333 is a portion allowing one side of the coil unit 200 in the second direction to be seated and supported thereon and then to be inserted into the inner accommodation recess 314 in the first bobbin 310. Therefore, the vertical thickness of the seating support portion 333 in the first direction may be set in consideration of the vertical length of the inner accommodation recess 314 in the first direction.

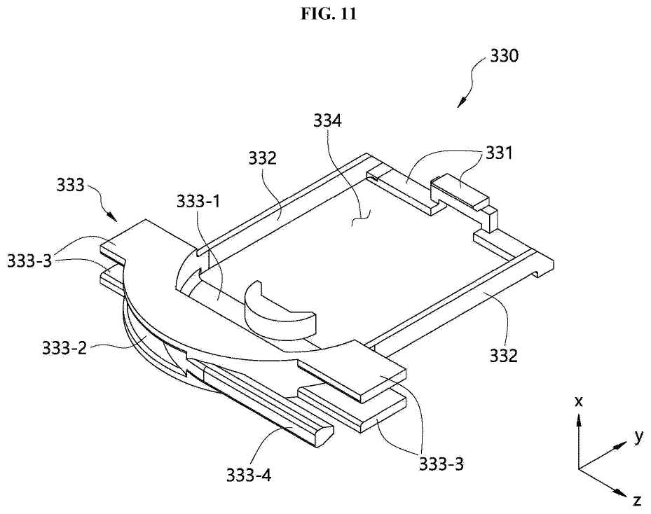

The seating support portion 333 may include a first seating portion 333-1, a second seating portion 333-2, a support portion 333-3, and a guide bar 333-4. However, the second seating portion 333-2 is not visible in FIG. 6 due to a viewing angle, and will be described with reference to FIG. 11.

The first seating portion 333-1 may be a portion on which one side of the primary coil 210 in the second direction is seated and supported while being maintained in a donut-shaped winding form and may be formed in a shape corresponding to the shape of one side of the primary coil 210.

The second seating portion 333-2 may be a portion around which one side of the secondary coil 220 in the second direction that is maintained in a winding form is wound while being in contact therewith and supported thereon. The second seating portion 333-2 may be formed to have a radius corresponding to one side of the secondary coil 220. In this case, the secondary coil 220 may be coupled to the second seating portion 333-2 in the state in which a portion thereof is flipped. The structure in which the secondary coil 220 is seated in a flipped state will be described later. The first seating portion 333-1 and the second seating portion 333-2 may be inserted into the inner accommodation recess 314 in the first bobbin 310.

At least a portion of the third fastening member 331 may be inserted into and disposed in the rectangular frame of the first fastening member 311. In this case, the third fastening member 331 may be inserted into and disposed in the rectangular frame of the first bobbin 310 in the state of being engaged with the second fastening member 321 of the second bobbin 320. That is, the third fastening member 331 may include a lower frame 331-1 extending in the third direction from the lower portion thereof in the first direction and may include a second fastening portion 331-2 that has a hook shape and extends upward from the center area of the lower frame 331-1 in the first direction and then extends toward one side of the third fastening member in the second direction. The second fastening portion 331-2 may be engaged with the first fastening portion 321-3 of the second bobbin 320 and may be disposed in the rectangular frame of the first fastening member 311. In addition, a recessed portion may be formed in the lower end of the second fastening portion 331-2. In this case, the first fastening member 311, the second fastening member 321, and the third fastening member 331 engaged with each other may form the fastening part CP. The length of the lower frame 331-1 in the third direction may correspond to an interval between the 2-1^{st} ribs 322. Third ribs 332 may be disposed between the third fastening member 331 and the seating support portion 333 so as to extend in the second direction. The third ribs 332 extending in the second direction may at least partially overlap the 2-1^{st} ribs 322 in the third direction.

When the first bobbin 310, the second bobbin 320, and the third bobbin 330 described above are coupled to each other, the bobbin unit 300 configured as shown in FIG. 7A may be formed. FIG. 7A is a view showing the configuration of the bobbin unit 300 according to the present disclosure when viewed from above.

Referring to FIG. 7A, the first end part FP of the first bobbin 310 may be disposed on one side (left) of the bobbin unit 300 according to the present disclosure in the second direction, and the second end part SP may be disposed on the other side (right) of the bobbin unit 300 in the second direction. The placement positions of the first end part FP and the second end part SP may be set to be opposite those exemplified above.

The intermediate part may be disposed between the first end part FP in which the inner accommodation recess 314 is formed and the second end part SP composed of the coil support portion 325. The intermediate part may be composed of the plurality of ribs 313, 322, 323, and 332 and the fastening part CP.

Although only the first fastening member 311 is shown in FIG. 7A due to a viewing angle, it is to be understood that the second fastening member 321 and the third fastening member 331 are disposed on the lower surface of the first fastening member 311 while being engaged with each other. Meanwhile, the first fastening member 311 may form the overall skeleton of the fastening part CP.

The plurality of ribs 313, 322, 323, and 332 may include the first ribs 313, the 2-1^{st} ribs 322, the 2-2^{nd} ribs 323, and the third ribs 332, and will be described with reference to FIG. 7A.

First, the first ribs 313 may extend in the y-axis direction between the first end part FP and the fastening part CP and may be disposed parallel to each other in the z-axis direction.

In addition, for convenience of description, the 2-2^{nd} ribs 323 will be described first. The 2-2^{nd} ribs 323 may extend in the y-axis direction between the second end part SP and the fastening part CP, may be disposed parallel to each other in the z-axis direction, and may at least partially overlap the first ribs 313 in the y-axis direction.

In addition, the 2-1^{st} ribs 322 may be spaced inward from the 2-2^{nd} ribs 323 by a predetermined interval in the z-axis direction so as to be parallel to the 2-2^{nd} ribs 323 and may extend in the y-axis direction between the second end part SP and the fastening part CP. In this case, the “predetermined interval” may be an interval corresponding to the width of the secondary coil 220 in the z-axis direction.

In addition, the third ribs 332 may be spaced inward from the first ribs 313 by a predetermined interval in the z-axis direction so as to be parallel to the first ribs 313 and may extend in the y-axis direction between the first end part FP and the fastening part CP. In this case, the third ribs 332 may at least partially overlap the 2-1^{st} ribs 322 in the y-axis direction.

In addition, the first ribs 313 and the third ribs 323 may at least partially overlap each other in the z-axis direction, and the 2-1^{st} ribs 322 and the 2-2^{nd} ribs 323 may at least partially overlap each other in the z-axis direction.

The plurality of ribs 313, 322, 323, and 332 described above may be disposed while forming through-holes 315, 324, 326, and 334 facing in the x-axis direction, and the first outer leg portions 111 and 121, the second outer leg portions 112 and 122, and the center leg portions 113 and 123 of the above-described core unit 100 may be disposed through the through-holes 315, 324, 326, and 334. Therefore, the first ribs 313 and the third ribs 332 of the bobbin unit 300 may be accommodated in the first space 130 in the above-described first core and may also be accommodated in the second space 140 in the first core. In addition, it is to be understood that the 2-2^{nd} ribs 323 and the 2-1^{st} ribs 322 are accommodated in the first space 130 in the second core and are also accommodated in the second space 140 in the second core.

FIGS. 7B to 7D are cross-sectional views of portions A-A, B-B, and C-C in FIG. 7A, which show the engagement state and the structure of the fastening part CP.

First, referring to FIG. 7B together with FIG. 7A, the third fastening member 331 connected to the third bobbin 330 may include a lower frame 331-1 and a second fastening portion 331-2. In addition, the second fastening member 321 connected to the second bobbin 320 may include an upper frame 321-1 and a first fastening portion 321-3. The first fastening portion 321-3 may be a recessed portion formed in the center portion of the upper frame 321-1 in the z-axis direction so as to be recessed downward in the x-axis direction, and an end portion of the recessed portion may include a shape bent toward the other side in the y-axis direction (right in FIG. 7B). The second fastening portion 331-2 may be disposed at the central portion of the lower frame 331-1 in the z-axis direction and may extend upward in the x-axis direction, and an extending end portion may include a shape bent toward one side in the y-axis direction (left in FIG. 7B). In this case, the lower end of the second fastening portion 331 may have a recessed portion formed therein in order to accommodate the end portion of the recessed portion of the first fastening portion 321-3 that is bent toward the other side in the y-axis direction (right in FIG. 7B). That is, as shown in the enlarged view in FIG. 7B, the first fastening portion 321-3 and the second fastening portion 331-2 may be in contact with and supported by each other in a complementary engagement form, and the upper and lower portions thereof in the x-axis direction may be surrounded by the first fastening member 311.

Next, referring to FIG. 7C together with FIG. 7A, one end portion of the 2-1^{st} rib 322 in the y-axis direction (left in FIG. 7C) may be formed to be inclined. In addition, the other end portion of the third rib 332 in the y-axis direction (right in FIG. 7C) may be formed to be inclined corresponding to one end portion of the 2-1^{st} rib 322 in the y-axis direction. That is, as shown in the enlarged view in FIG. 7C, the inclined surfaces of the end portions of the 2-1^{st} rib 322 and the third rib 332 may be in surface contact with each other, and the upper and lower portions thereof in the x-axis direction may be surrounded by the first fastening member 311. Although not shown in the drawings, the end portions of the respective ribs may be formed to be inclined in directions opposite the inclination directions shown in FIG. 7C and may be in surface contact with each other. In this case, the 2-1^{st} rib 322 and the third rib 332 may be disposed so as to at least partially overlap each other in the y-axis direction.

In addition, referring to FIG. 7D together with FIG. 7A, the first fastening member 311 may be formed on the other end of the first rib 313 in the y-axis direction (right in FIG. 7D). A seating recess 311-1 may be formed in each of the upper and lower portions of the first fastening member 311 in the z-axis direction so as to be open toward the other side in the y-axis direction. A support piece 321-2 may be formed on each of the upper and lower portions of the 2-2^{nd} rib 323 in the z-axis direction that face toward one side in the y-axis direction (left in FIG. 7D) so as to be inserted into and supported by the seating recess 311-1.

Because the intermediate part, rather than the first end part FP and the second end part SP, forms the through-holes 315, 324, 326, and 334 facing in the x-axis direction, although upper and lower surfaces of the bobbin unit 300 in the x-axis direction are omitted, the overall rigidity of the bobbin unit 300 according to the present disclosure may be improved and ensured due to the above-described structures of the plurality of ribs 313, 322, 323, and 332 and the fastening part CP.

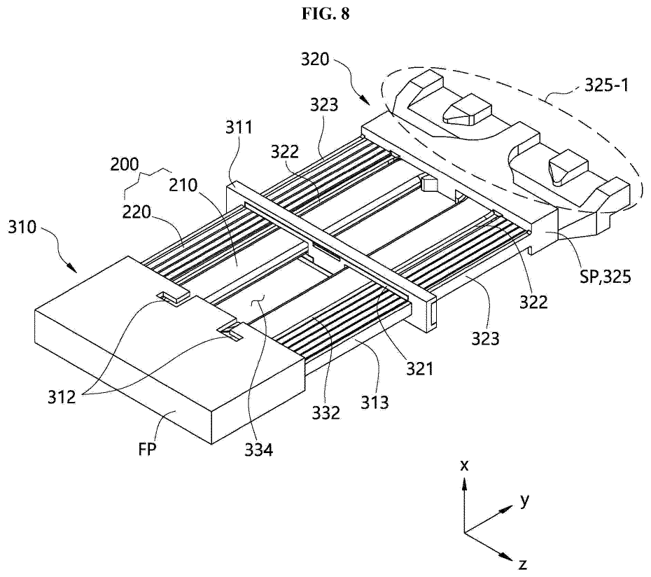

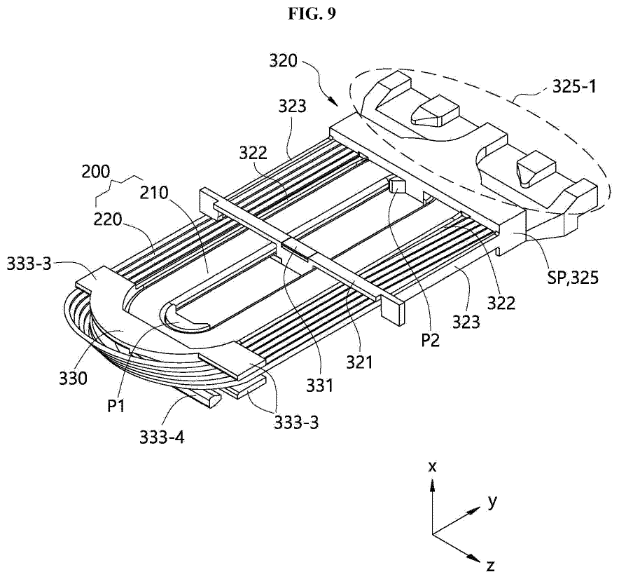

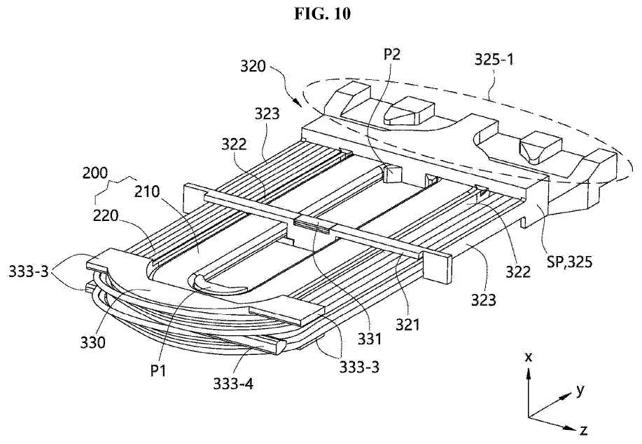

FIG. 8 is a perspective view showing a state in which the core unit is removed from the transformer according to the present disclosure, FIG. 9 is a perspective view showing a state in which the first bobbin is removed from FIG. 8, FIG. 10 is a perspective view showing a state in which the secondary coil is formed in two rows in FIG. 9, and FIG. 11 is a perspective view showing the third bobbin according to the present disclosure. FIGS. 8 to 11 are views showing the placement structure and the coupling state of the coil unit disposed on the bobbin unit applied to the present disclosure.

First, referring to FIG. 8, the coil unit 200 composed of the primary coil 210 and the secondary coil 220 may be maintained in a donut-shaped winding form. One end portion of the coil unit 200 (in the left-lower oblique direction) may be disposed on the first end part FP of the bobbin unit 300, and the other end portion of the coil unit 200 (in the right-upper oblique direction) may be disposed on the second end part SP of the bobbin unit 300. In addition, the intermediate portion of the coil unit 200, rather than one end portion and the other end portion of the coil unit 200, may be disposed on the intermediate part of the bobbin unit 300, that is, in an area in which the first ribs 313, the 2-1^{st} ribs 322, the 2-2^{nd} ribs 323, and the third ribs 332 are disposed, rather than the first end part FP and the second end part SP of the bobbin unit 300. In this case, the primary coil 210 may be disposed on the bobbin unit 300 while being maintained in a donut-shaped winding form along the y-axis plane, and the secondary coil 220 may be disposed on the bobbin unit 300 while being maintained in a winding form along the outer periphery of the wound primary coil 210. That is, the primary coil 210 may be wound in a donut shape while having a width corresponding to the widths of the first fastening portion 321-3 and the second fastening portion 331-2 in the z-axis direction. Thus, one end portion of the primary coil 210 may be disposed inside the first end part FP of the bobbin unit 300, the other end portion of the primary coil 210 may be disposed inside the second end part SP of the bobbin unit 300, and the intermediate portion of the primary coil 210 may be disposed along the inner peripheral surfaces of the 2-1^{st} ribs 322 and the third ribs 332 in the z-axis direction. In addition, the secondary coil 220 may be disposed along the outer periphery of the wound primary coil 210. That is, one end portion of the secondary coil 220 may be disposed along the outer periphery of the primary coil 210 inside the first end part FP of the bobbin unit 300, and the intermediate portion of the secondary coil 220 may be disposed between the 2-1^{st} and third ribs 322 and 332, which at least partially overlap each other in the y-axis direction, and the first and 2-2^{nd} ribs 313 and 323, which at least partially overlap each other in the y-axis direction. In this case, the first and 2-2^{nd} ribs 313 and 323 may be spaced horizontally from the 2-1^{st} and third ribs 322 and 332 in the z-axis direction by a predetermined interval corresponding to or greater than the winding width of the secondary coil 220. Meanwhile, the secondary coil 220 disposed inside the second end part SP of the bobbin unit 300 may be supported and guided outside the second bobbin 320 by the coil support portion 325.

In addition, one end portion of the coil unit 200 may be inserted into the inner accommodation recess 314 in the first bobbin 310 in the state of being fitted in the seating support portion 333 of the third bobbin 330, and the inner insertion structure will be described with reference to FIG. 9.

FIG. 9 shows a state in which the first bobbin 310 is removed from FIG. 8. Reference numerals 333-1 and 333-2 shown in FIGS. 2 and 6 are omitted from FIG. 9. Thus, FIGS. 2 and 6 will also be referenced in the description of the configuration shown in FIG. 9. Referring to the drawings, one end portion of the primary coil 210 of the above-described coil unit 200 may be seated on the first seating portion 333-1 of the seating support portion 333. A seating protrusion P1, which has a radius corresponding to the inner radius of the primary coil 210 and a width corresponding to the widths of the first fastening portion 321-3 and the second fastening portion 331-2 in the z-axis direction, may be formed on the first seating portion 333-1. In this case, a mounting protrusion P2 corresponding to the seating protrusion P1 may be formed on the lower portion of the coil support portion 325 of the second bobbin 320 in the x-axis direction. The mounting protrusion P2 may have a structure allowing the other end portion of the primary coil 210 to be fitted and mounted therein. Due to the seating protrusion P1 and the mounting protrusion P2, the winding forms of the primary coil 210 and the secondary coil 220 may be maintained, and short circuit between the wires thereof may be prevented.

In addition, the secondary coil 220 applied to the present disclosure may be wound along the outer periphery of the second seating portion 333-2 of the seating support portion 333 disposed on one side of the third bobbin 330 (in the left-lower oblique direction) in the state in which a portion of the secondary coil 220 is flipped once, rather than a plurality of wires of the secondary coil 220 being wound around the bobbin unit 300. That is, the portion of the secondary coil 220 located around the second seating portion 333-2 may be flipped once such that an outer wire of the secondary coil 220 is disposed at an inner portion of the secondary coil 220 and an inner wire of the secondary coil 220 is disposed at an outer portion of the secondary coil 220. In this way, because the secondary coil 220 is flipped once, a current flowing through the inner path flows to the outer path, and a current flowing through the outer path flows to the inner path. Accordingly, it may be possible to control inductance variation caused by a difference in length between the wires. The inductance variation generally causes heat generation during operation of the transformer. The embodiment may lower the overall temperature of the transformer. However, at the flipped point C1 of the secondary coil 220, external force may be applied to the wire, whereby, for example, a sheath may be peeled off, and withstand voltage may be reduced. Therefore, in order to solve this problem, the inner accommodation recess 314 may be formed in the first bobbin 310, and the seating support portion 333 around which one end portion of each of the primary coil 210 and the secondary coil 220 is wound may be inserted into the inner accommodation recess 314 so as not to be exposed.

In addition, the second seating portion 333-2 may include a pair of support portions 333-3 protruding in the z-axis direction from the side surfaces of one side portion and the other side portion thereof in the z-axis direction while being spaced apart from each other in the x-axis direction. The secondary coil 220 may be disposed between the support portions 333-3 spaced apart from each other. In this case, the portion of the secondary coil 220 disposed between the support portions 333-3 formed on one side portion of the second seating portion 333-2 (in the left-upper oblique direction in FIG. 9) may be flipped once, and the flipped portion of the secondary coil 220 may be guided to the support portions 333-3 formed on the other side portion of the second seating portion 333-2 while contacting the upper portion or the lower portion of the guide bar 333-4 in the x-axis direction.

In addition, as shown in FIG. 10, if the secondary coil 220 is formed in two or more rows in the x-axis direction, the above-described flipped portions of the secondary coil 220 may be separated vertically from each other and guided to the support portions 333-3 formed on the other side portion of the second seating portion 333-2 by the guide bar 333-4.

FIG. 11 is a view for understanding the structure of the support portions 333-3 and the guide bar 333-4 of the third bobbin 330. A spacing distance between the support portions 333-3 in the x-axis direction may correspond to or be greater than the thickness of the secondary coil 220 in the x-axis direction. In addition, the guide bar 333-4 may protrude in the z-axis direction from the other side portion of the second seating portion 333-2 and may extend in the winding direction of the secondary coil 220. The protruding length of the guide bar 333-4 may be less than or equal to the protruding length of the support portions 333-3 disposed at the other side portion of the second seating portion 333-2. The protruding position of the guide bar 333-4 may be disposed between the support portions 333-3 in the y-axis direction. The guide bar 333-4 may be formed in various shapes, for example, a rod shape.

Hereinafter, a transformer according to a further embodiment will be described with reference to the accompanying drawings. The transformer according to the further embodiment will be described with reference to the above-described transformer having the segmented cores and the segmented bobbins shown in FIGS. 1 to 11, but the embodiments are not limited thereto. That is, the transformer to be described below may also be applied to a configuration in which the core unit 100 is not segmented into the first core and the second core, and may also be applied to a configuration in which the bobbin unit 300 is not segmented into the first to third bobbins 310, 320, and 330.

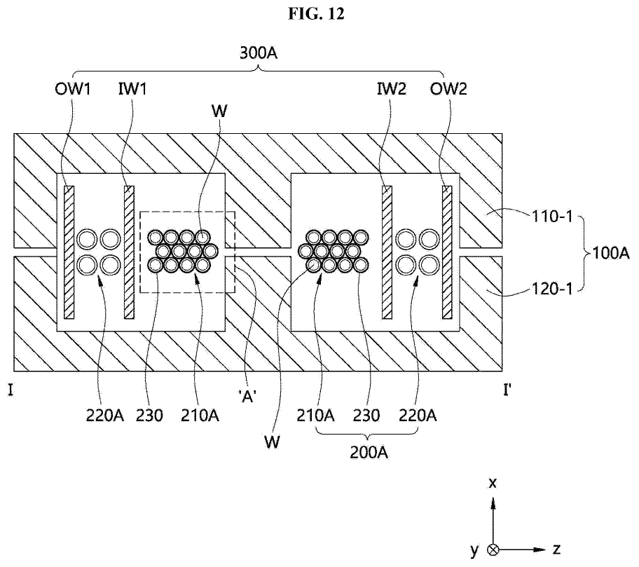

FIG. 12 is a cross-sectional view of a transformer according to a further embodiment.

FIG. 12 may correspond to a cross-sectional view taken along line I-I′ in the transformer shown in FIG. 1.

The transformer according to the further embodiment may include a core unit 100A, a coil unit 200A, and a bobbin unit 300A.

The core unit 100A may correspond to the above-described core unit 100. Alternatively, unlike the above-described core unit 100, the core unit 100A may include only one of the first and second cores.

The core unit 100A may include an upper core 110-1 and a lower core 120-1. If the core unit 100A includes only one of the first and second cores, the core unit 100A may include an upper core 110-1 (or 110-2) and a lower core 120-1 (or 120-2), and redundant descriptions thereof will be omitted.

Hereinafter, the core unit 100A will be described as corresponding to the above-described core unit 100.

The bobbin unit 300A may correspond to the above-described bobbin unit 300. Alternatively, unlike the above-described bobbin unit 300, the bobbin unit 300A may have a configuration in which the first to third bobbins 310, 320, and 330 are formed integrally. If the first to third bobbins 310, 320, and 330 are formed integrally, the above-described fastening part CP included in the bobbin unit 300 may be omitted.

The bobbin unit 300A may be at least partially disposed inside the core unit 100A and may accommodate at least a part of the coil unit 200A.

Hereinafter, the bobbin unit 300A will be described as corresponding to the above-described bobbin unit 300.

Meanwhile, the coil unit 200A may include a primary coil 210A, a secondary coil 220A, and a second insulating portion 230, and may be at least partially disposed inside the core unit 100A. The primary coil 210A and the secondary coil 220A may perform the same functions as the primary coil 210 and the secondary coil 220 described above, respectively.

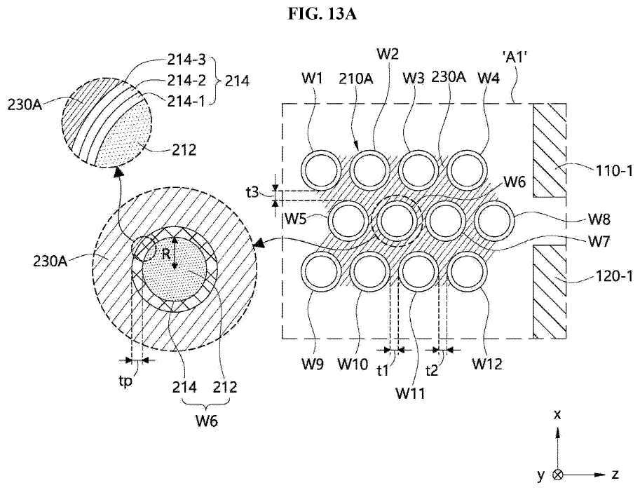

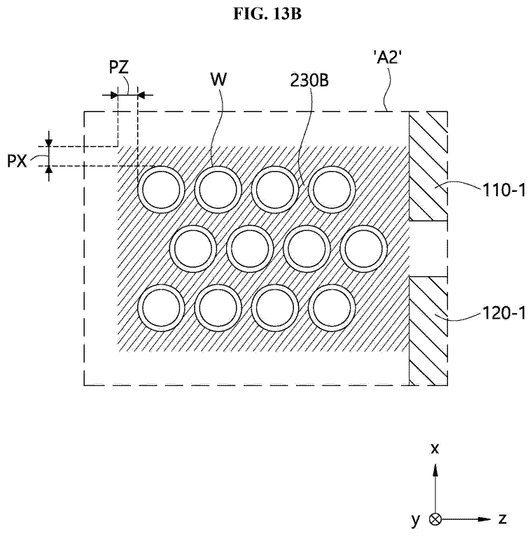

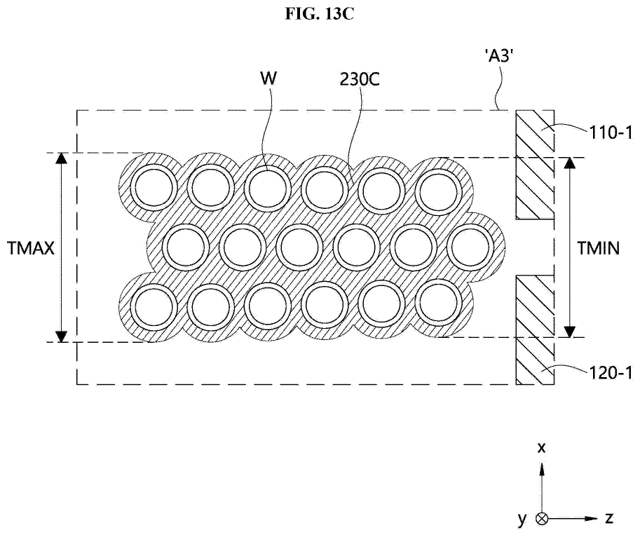

FIGS. 13A to 13C show embodiments A1, A2, and A3 of portion “A” shown in FIG. 12.

The primary coil 210A may have a cross-sectional shape including a plurality of wires W. In the configuration shown in FIGS. 12, 13A, and 13B, twelve wires are illustrated, and in the configuration shown in FIG. 13C, eighteen wires are illustrated. However, the number of wires may be greater or less than the illustrated number.

Each of the plurality of wires W shown in FIGS. 12, 13B, and 13C may include a conductor 212 and a first insulating portion 214, as shown in FIG. 13A.

The conductor 212 is electrically conductive. To this end, the conductor 212 may include an electrically conductive material, such as copper. That is, the conductor 212 corresponds to the core conductor of the wire W. As shown in the drawings, the conductor 212 may have a circular cross-sectional shape with a radius R. However, the embodiments are not limited to any specific cross-sectional shape of the conductor 212.

The first insulating portion 214 may be an insulation coating surrounding the conductor 212. For example, the first insulating portion 214 may be a triple insulating layer including first to third insulation coating layers 214-1, 214-2, and 214-3 that are stacked in three layers, as shown in FIG. 13A. The first insulation coating layer 214-1 may be disposed in contact with the conductor 212, the third insulation coating layer 214-3 may be disposed on the outermost side of the wire W, and the second insulation coating layer 214-2 may be disposed between the first insulation coating layer 214-1 and the third insulation coating layer 214-3. The thickness tp of the first insulating portion 214 may be uniform.

In this case, according to another embodiment, the coil unit 200A may further include a second insulating portion 230 disposed between the plurality of wires W. The second insulating portion 230 may include a material having adhesiveness and insulating properties. For example, the second insulating portion 230 may be implemented using a polymer resin, such as a polyvinyl-based resin, polyethylene-based resin, fluorine-based resin, silicone-based resin, or nylon. Accordingly, the plurality of wires W may be bonded to each other by the second insulating portion 230. According to the embodiment, the second insulating portion 230 may be implemented in various forms, such as the second insulating portions 230A, 230B, and 230C shown in FIG. 12 and FIGS. 13A to 13C.

According to one embodiment, as shown in FIG. 13A, the second insulating portion 230A may include only a portion disposed between the plurality of wires W (hereinafter referred to as a “first portion”).

According to another embodiment, as shown in FIG. 12, FIG. 13B, or FIG. 13C, the second insulating portion 230B or 230C may include not only the first portion disposed between the plurality of wires W but also a portion disposed on the outer side of the primary coil 210A (hereinafter referred to as a “second portion”). For example, as shown in FIG. 13B, the second portion of the second insulating portion 230A may include at least one of portions PZ and PX that extend from the first portion disposed between the plurality of wires W to surround the outer periphery of the primary coil 210A.

For example, the primary coil 210A may be formed by winding the wire W on a jig and then coating a bonding material as the second adhesive portion 230 onto the surface of the first adhesive portion 214. However, the embodiments are not limited to any specific method of manufacturing the primary coil 210A.

According to the embodiment, the variation in the minimum thickness of the second insulating portion 230 disposed between the plurality of wires W may be within 7%.

For example, let the minimum thickness of the second insulating portion 230 disposed between adjacent first and second wires W1 and W2 be referred to as a first minimum thickness, the minimum thickness of the second insulating portion 230 disposed between adjacent second and third wires W2 and W3 be referred to as a second minimum thickness, the minimum thickness of the second insulating portion 230 disposed between adjacent third and fourth wires W3 and W4 be referred to as a third minimum thickness, the minimum thickness of the second insulating portion 230 disposed between adjacent fourth and eighth wires W4 and W8 be referred to as a fourth minimum thickness, the minimum thickness of the second insulating portion 230 disposed between adjacent eighth and seventh wires W8 and W7 be referred to as a fifth minimum thickness, the minimum thickness of the second insulating portion 230 disposed between adjacent seventh and sixth wires W7 and W6 be referred to as a sixth minimum thickness, the minimum thickness of the second insulating portion 230 disposed between adjacent sixth and fifth wires W6 and W5 be referred to as a seventh minimum thickness, the minimum thickness of the second insulating portion 230 disposed between adjacent fifth and ninth wires W5 and W9 be referred to as an eighth minimum thickness, the minimum thickness of the second insulating portion 230 disposed between adjacent ninth and tenth wires W9 and W10 be referred to as a ninth minimum thickness, the minimum thickness t1 of the second insulating portion 230 disposed between adjacent tenth and eleventh wires W10 and W11 be referred to as a tenth minimum thickness, the minimum thickness t2 of the second insulating portion 230 disposed between adjacent eleventh and twelfth wires W11 and W12 be referred to as an eleventh minimum thickness, the minimum thickness t3 of the second insulating portion 230 disposed between adjacent first and fifth wires W1 and W5 be referred to as a twelfth minimum thickness, the minimum thickness of the second insulating portion 230 disposed between adjacent second and fifth wires W2 and W5 be referred to as a thirteenth minimum thickness, the minimum thickness of the second insulating portion 230 disposed between adjacent second and sixth wires W2 and W6 be referred to as a fourteenth minimum thickness, the minimum thickness of the second insulating portion 230 disposed between adjacent third and sixth wires W3 and W6 be referred to as a fifteenth minimum thickness, the minimum thickness of the second insulating portion 230 disposed between adjacent third and seventh wires W3 and W7 be referred to as a sixteenth minimum thickness, the minimum thickness of the second insulating portion 230 disposed between adjacent fourth and seventh wires W4 and W7 be referred to as a seventeenth minimum thickness, the minimum thickness of the second insulating portion 230 disposed between adjacent fifth and ninth wires W5 and W9 be referred to as an eighteenth minimum thickness, the minimum thickness of the second insulating portion 230 disposed between adjacent fifth and tenth wires W5 and W10 be referred to as a nineteenth minimum thickness, the minimum thickness of the second insulating portion 230 disposed between adjacent sixth and tenth wires W6 and W10 be referred to as a twentieth minimum thickness, the minimum thickness of the second insulating portion 230 disposed between adjacent sixth and eleventh wires W6 and W11 be referred to as a twenty-first minimum thickness, the minimum thickness of the second insulating portion 230 disposed between adjacent seventh and eleventh wires W7 and W11 be referred to as a twenty-second minimum thickness, and the minimum thickness of the second insulating portion 230 disposed between adjacent seventh and twelfth wires W7 and W12 be referred to as a twenty-third minimum thickness.

In this case, the variation among the first to twenty-third minimum thicknesses may be within 7%.

For example, the tenth, eleventh, and twelfth minimum thicknesses t1, t2, and t3 of the second insulating portion 230 shown in FIG. 13A may be equal to one another, and the difference or variation among the minimum thicknesses t1, t2, and t3 may be within 7%, or may be greater than the thickness tp of the first insulating portion 214 and less than the radius R of the wire 210A.

As described above, when the variation in the minimum thickness of the second insulating portion 230 is within a predetermined range, the variation in the minimum distance by which adjacent wires among the plurality of wires W are spaced apart from each other may also be within the predetermined range. For example, the minimum distance by which adjacent wires among the plurality of wires W are spaced apart from each other may correspond to the minimum thickness of the second insulating portion disposed between the adjacent wires.

In addition, the thickness of the primary coil when viewed in a sectional view may have a variation. For example, referring to FIG. 13C, in the embodiment, the difference or variation between the minimum thickness TMIN and the maximum thickness TMAX of the primary coil 210A when viewed in a sectional view may be greater than the thickness tp of the first insulating portion 214 and less than the radius R of each of the plurality of wires. For example, the difference or variation between the minimum thickness TMIN and the maximum thickness TMAX may be 7% or less.

Meanwhile, the secondary coil 220A may be disposed to be spaced apart from the primary coil 210A.

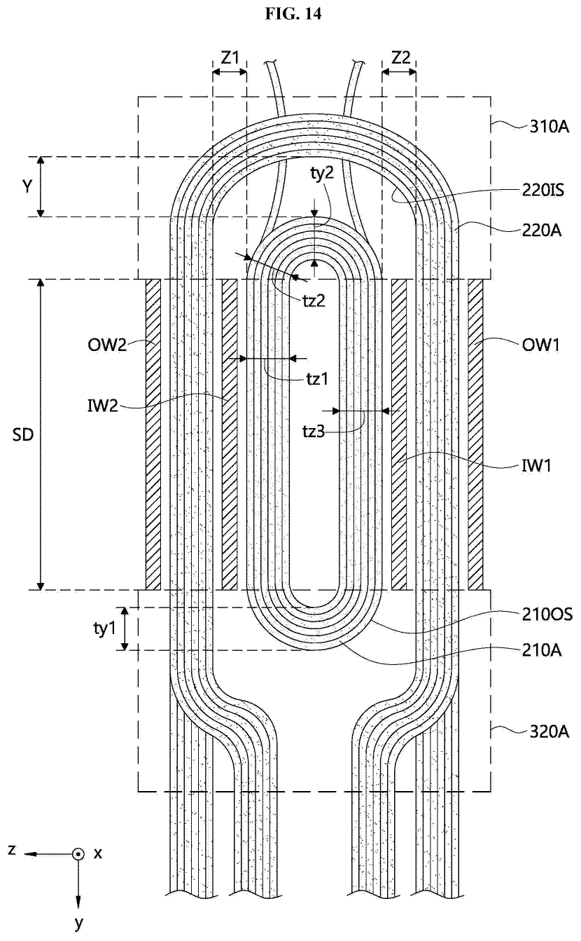

FIG. 14 is a plan view showing an embodiment of the transformer shown in FIG. 12.

In the transformer shown in FIG. 14, illustration of the core unit 100A is omitted, and a first bobbin 310A and a second bobbin 320A are shown in dashed lines. In addition, as will be described later, portions of inner partition walls IW1 and IW2 may correspond to a third bobbin 330A.

As such, the transformer may include the first to third bobbins 310A, 320A, and 330A. The first and second bobbins 310A and 320A may be disposed to face each other with the coil unit 200A interposed therebetween, and the third bobbin 330A may be disposed between the first and second bobbins 310A and 320A. The first to third bobbins 310A, 320A, and 330A may correspond to the above-described first to third bobbins 310, 320, and 330, respectively. However, the first to third bobbins 310A, 320A, and 330A may not include the fastening part CP, as shown in FIG. 14, or may include the fastening part CP, as shown in FIGS. 1 to 11.

As shown in FIG. 14, the inner circumferential portion 220IS of the secondary coil 220A may be disposed along the outer circumferential portion 210OS of the primary coil 210A.

For example, referring to FIG. 14, the widths ty1 and ty2 of the primary coil 210A in the second direction and the widths tz1, tz2, and tz3 thereof in the third direction may be equal to one another or may be different from one another.

According to the embodiment, the difference or variation between the minimum width and the maximum width of the primary coil 210A when viewed in a plan view may be within 7%, or may be greater than the width of the first insulating portion 214 and less than the radius R of each of the plurality of wires 210A.

The variation in the distance by which the outer circumferential portion 210OS and the inner circumferential portion 220IS are spaced apart from each other in at least one of the long-axis direction or the short-axis direction of the transformer may be within 7%.

In the configuration in FIG. 14, the long-axis direction may be the second direction, and the short-axis direction may be the third direction. The variation in the spacing distance (e.g., Y) between the outer circumferential portion 210OS and the inner circumferential portion 220IS in the second direction, which is the long-axis direction, may be within 7%, and the variation in the spacing distances (e.g., Z1 and Z2) between the outer circumferential portion 210OS and the inner circumferential portion 220IS in the third direction, which is the short-axis direction, may be within 7%.

As described above, the difference or variation between the minimum width and the maximum width of the primary coil 210A when viewed in a plan view may cause a variation in the spacing distance between the outer circumferential portion 210OS and the inner circumferential portion 220IS in at least one of the long-axis direction or the short-axis direction.

According to the embodiment, the spacing distance between the outer circumferential portion 210OS and the inner circumferential portion 220IS may be determined according to a desired leakage inductance (i.e., target leakage inductance).

Furthermore, the variation in the spacing distance (e.g., Y) between the outer circumferential portion 210OS and the inner circumferential portion 220IS in the long-axis direction (e.g., the second direction) may be equal to the variation in the spacing distances (e.g., Z1 and Z2) between the outer circumferential portion 210OS and the inner circumferential portion 220IS in the short-axis direction (e.g., the third direction).

Meanwhile, the bobbin unit 300A of the transformer according to the embodiment may include inner partition walls IW1 and IW2 and may further include outer partition walls OW1 and OW2.

The inner partition walls IW1 and IW2 may be disposed between the primary coil 210A and the secondary coil 220A. The outer partition walls OW1 and OW2 define a space in which the secondary coil 220A is accommodated together with the inner partition walls IW1 and IW2. In some embodiments, the outer partition walls OW1 and OW2 may be omitted.

The height of each of the inner partition walls IW1 and IW2 and the outer partition walls OW1 and OW2 in the first direction may be equal to or greater than the thickness of the secondary coil 220A in the first direction.

The inner partition walls IW1 and IW2 shown in FIG. 14 may be implemented by the plurality of 2-1^{st} ribs 322 and the plurality of third ribs 332 described above. The plurality of third ribs 332 may extend from the seating support portion 333 toward the second bobbin 320A and may overlap the plurality of 2-1^{st} ribs 322 in the second direction, respectively. For example, one side of the coil unit 200A may be disposed on the seating support portion 333, and at least part of the seating support portion 333 may be accommodated in the first end part FP. Since the seating support portion 333, the first end part FP, the plurality of 2-1^{st} ribs 322, and the plurality of third ribs 332 are identical to those described with reference to FIGS. 1 to 11, redundant descriptions thereof will be omitted.

The outer partition walls OW1 and OW2 may be implemented by the plurality of first ribs 313 and the plurality of 2-2^{nd} ribs 323 described above. The plurality of first ribs 313 extends from the first end part FP toward the second bobbin 320A and is disposed parallel to each other in the third direction.

The plurality of 2-2^{nd} ribs 323 extends from the second end part SP, on which the other side of the coil unit 200A is disposed, toward the first bobbin 310A and overlaps the plurality of first ribs 313 in the second direction, respectively. Since the second end part SP, the plurality of first ribs 313, and the plurality of 2-2^{nd} ribs 323 are identical to those described with reference to FIGS. 1 to 11, redundant descriptions thereof will be omitted.

According to the embodiment, the plurality of wires W of the primary coil 210A is tightly bonded to one another by the second adhesive portion 230 to form a uniform winding form, and accordingly, the wound primary coil 210A may be fitted into and fixed in an inner space between the inner partition walls IW1 and IW2.

In addition, a space is defined by the outer partition walls OW1 and OW2 and the inner partition walls IW1 and IW2, and accordingly, the wound secondary coil 220A may be fitted into and fixed in this space.

Hereinafter, a transformer according to a comparative example and the transformer according to the embodiment will be described with reference to the accompanying drawings.

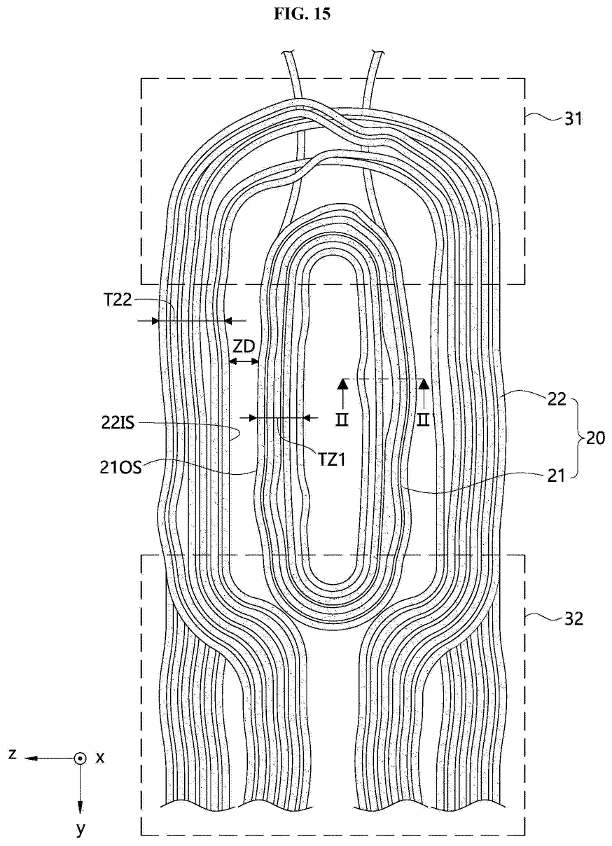

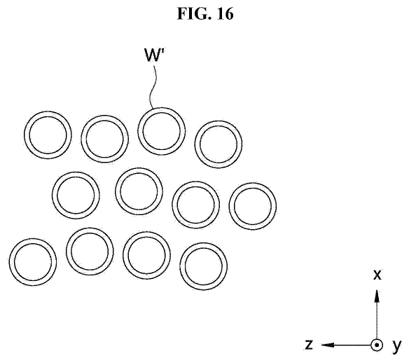

FIG. 15 is a plan view of the transformer according to the comparative example, and FIG. 16 is a cross-sectional view of the primary coil 21 taken along line II-II′ in FIG. 15.

The transformer according to the comparative example shown in FIG. 15 may include a coil unit 20 and first and second bobbins 31 and 32.

The coil unit 20, the first bobbin 31, and the second bobbin 32 perform the same functions as the coil unit 200A, the first bobbin 310A, and the second bobbin 320A according to the embodiment, respectively, and thus redundant descriptions thereof will be omitted. The coil unit 20 includes a primary coil 21 and a secondary coil 22. The primary coil 21 and the secondary coil 22 perform the same functions as the primary coil 210A and the secondary coil 220A according to the embodiment, respectively, and thus redundant descriptions thereof will be omitted.

As shown in FIG. 16, the primary coil 21 according to the comparative example has a cross-sectional shape including a plurality of wires W′. The second adhesive portion 230 is not present between the plurality of wires W′, unlike the embodiment. Thus, the plurality of wires W′ maintains the winding form only by tension. Accordingly, the variation in the minimum distance between the plurality of wires W′ is large. That is, in the comparative example, the primary coil 21 is formed by winding the wires W′ around a pillar of a bobbin, and as the number of turns of the wires W′ increases, the wound wires W′ spread laterally into an elliptical shape and have an irregular profile, as shown in FIG. 15. As a result, the variation in the width TZ1 of the primary coil 21 when viewed in a plan view becomes large. In a plurality of transformers manufactured in this manner, the winding forms of the primary coils 21 may have different sizes due to winding tolerances generated when the wires are wound on the bobbin.

In addition, the variation in the spacing distance ZD between the outer circumferential portion 21OS of the primary coil 21 and the inner circumferential portion 22IS of the secondary coil 22 is also large. This variation may increase as the transformer becomes slimmer. When the variation in the spacing distance ZD is large as described above, there is a problem in that the variation in leakage inductance, which is determined by the distance between the primary coil 21 and the secondary coil 22, increases.

In contrast, in the embodiment, the second adhesive portion 230 having adhesiveness is present between the plurality of wires W, so that the neighboring wires W may be bonded to each other by the second adhesive portion 230. Therefore, in the embodiment, the variation in the minimum distance between the plurality of wires W may be significantly reduced compared to the comparative example. As a result, the variation among the widths tz1, tz2, tz3, ty1, and ty2 of the primary coil 210A when viewed in a plan view may be less than that in the comparative example. Moreover, in a plurality of transformers manufactured in this manner, the winding forms of the primary coils 210A may have a more uniform size than in the comparative example. Furthermore, the variation among the spacing distances Z1, Z2, and Y between the outer circumferential portion 210OS of the primary coil 210A and the inner circumferential portion 220IS of the secondary coil 220A may also be less than in the comparative example. Thus, when the variation among the spacing distances Z1, Z2, and Y is reduced, the variation in leakage inductance may be reduced, and the leakage inductance may be kept constant compared to the comparative example.

Furthermore, as in the embodiment, when the wires W of the primary coil 210A are bonded by the second adhesive portion 230 and thus the winding form thereof becomes uniform, the spacing distance SD between the first bobbin 310A and the second bobbin 320A in the second direction may also become uniform.

Furthermore, in the comparative example, a bobbin is needed to hold the center of the wound primary coil 21. In contrast, in the embodiment, since the wires W of the primary coil 210A are tightly bonded to one another by the second adhesive portion 230, there is no need for the fastening part CP including the fastening member 321-3 of the bobbin unit 300A that holds the center of the primary coil 21, making the structure of the bobbin unit 300A simpler.

Furthermore, in the embodiment, since the inner partition walls IW1 and IW2 are present, the spacing distance between the primary coil 210A and the secondary coil 220A may be maintained more uniformly, and accordingly, the variation in leakage inductance may become more uniform. Moreover, since the outer partition walls OW1 and OW2 are present, the secondary coil 220A may be accommodated in the space defined by the outer partition walls OW1 and OW2 and the inner partition walls IW1 and IW2, and may thus be fixed in position without shifting. As a result, the spacing distance between the primary coil 210A and the secondary coil 220A may be precisely determined, allowing for accurate prediction and control of the variation in leakage inductance.

In particular, in the embodiment, since the winding form of the primary coil 210A is uniform, it may be possible to accommodate the secondary coil 220A in the space defined by the outer partition walls OW1 and OW2 and the inner partition walls IW1 and IW2.

Furthermore, in the comparative example, since the wires are directly wound on the bobbin to form the primary coil 21 and the secondary coil 22, the winding process is time-consuming and labor-intensive, and the winding form may be varied depending on winding work by operators or the like.

In contrast, in the embodiment, since the wound primary coil 210A and the wound secondary coil 220A are placed at respective positions in a fitting manner, the time and labor required to perform the winding process may be reduced, and the winding form may be maintained uniformly without being affected by external variables caused by operators or the like, thereby improving the quality of the transformer.

Meanwhile, the transformer according to the above-described embodiment may ensure a high and less variable leakage inductance value while allowing for a slim structure of the bobbin unit 300. Accordingly, a circuit board on which such a transformer is disposed may be applied to display devices, such as flat panel TVs.

While the present disclosure has been particularly shown and described with reference to exemplary embodiments thereof, these embodiments are only proposed for illustrative purposes, and do not restrict the present disclosure, and it will be apparent to those skilled in the art that various changes in form and detail may be made without departing from the essential characteristics of the embodiments set forth herein. For example, respective configurations set forth in the embodiments may be modified and applied. Further, differences in such modifications and applications should be construed as falling within the scope of the present disclosure as defined by the appended claims.

### MODE FOR DISCLOSURE

Various embodiments have been described in the best mode for carrying out the disclosure.

### INDUSTRIAL APPLICABILITY

The transformer and the display device including the same according to the embodiments may be applied to display devices, such as flat panel TVs, which require a power supply unit.

1. A transformer, comprising:
a core unit including an upper core and a lower core;
a coil unit including a primary coil and a secondary coil spaced apart from the primary coil, at least a portion of the coil unit being disposed inside the core unit; and
a bobbin unit configured to accommodate at least a portion of the coil unit, at least a portion of the bobbin unit being disposed inside the core unit,
wherein the primary coil has a cross-sectional shape including a plurality of wires,
wherein each of the plurality of wires includes:
a conductor; and
a first insulating portion surrounding the conductor, and
wherein the coil unit includes a second insulating portion disposed between the plurality of wires.

2. The transformer according to claim 1, wherein the first insulating portion includes three stacked insulation coating layers.

3. The transformer according to claim 1, wherein the second insulating portion includes an adhesive material.

4. The transformer according to claim 1, wherein the second insulating portion includes a portion extending from a region between the plurality of wires to surround an outer periphery of the primary coil.

5. The transformer according to claim 1, wherein a variation in a minimum thickness of the second insulating portion disposed between the plurality of wires is within 7%.

6. The transformer according to claim 1, wherein a variation in a minimum spacing distance between adjacent wires among the plurality of wires is within 7%.

7. The transformer according to claim 6, wherein the variation in the minimum distance is equal to or less than a thickness of the first insulating portion.

8. The transformer according to claim 1, wherein an inner circumferential portion of the secondary coil is disposed along an outer circumferential portion of the primary coil, and
wherein a variation in a spacing distance between the outer circumferential portion and the inner circumferential portion in at least one of a long-axis direction or a short-axis direction of the transformer is within 7%.

9. The transformer according to claim 8, wherein the variation is determined according to a target leakage inductance.

10. The transformer according to claim 8, wherein the variation in the long-axis direction and the variation in the short-axis direction are equal to each other.

11. The transformer according to claim 1, wherein a difference between a minimum thickness and a maximum thickness of the primary coil when viewed in a sectional view is greater than a thickness of the first insulating portion and less than a radius of each of the plurality of wires.

12. The transformer according to claim 1, wherein a difference between a minimum width and a maximum width of the primary coil when viewed in a plan view is greater than a width of the first insulating portion and less than a radius of each of the plurality of wires.

13. The transformer according to claim 1, wherein the bobbin unit includes an inner partition wall disposed between the primary coil and the secondary coil.

14. The transformer according to claim 13, wherein the bobbin unit includes an outer partition wall defining a space for accommodation of the secondary coil together with the inner partition wall.

15. The transformer according to claim 14, wherein the bobbin unit includes:
first and second bobbins disposed to face each other in a second direction with the coil unit interposed therebetween and;
a third bobbin disposed between the first and second bobbins,
wherein the first bobbin includes:
a first end part having one side of the coil unit disposed thereon; and
a plurality of first ribs extending from the first end part toward the second bobbin and disposed parallel to each other in a third direction intersecting the second direction,
wherein the second bobbin includes:
a second end part having an other side of the coil unit disposed thereon;
a plurality of 2-1st ribs; and
a plurality of 2-2nd ribs extending from the second end part toward the first bobbin and overlapping the plurality of first ribs in the second direction, respectively,
wherein the third bobbin includes:
a seating support portion having one side of the coil unit disposed thereon, at least a portion of the seating support portion being accommodated in the first end part; and
a plurality of third ribs extending from the seating support portion toward the second bobbin and overlapping the plurality of 2-1st ribs in the second direction, respectively,
wherein the plurality of first ribs and the plurality of 2-2nd ribs form the outer partition wall, and
wherein the plurality of 2-1st ribs and the plurality of third ribs form the inner partition wall.

16. The transformer according to claim 15, wherein a spacing distance between the first bobbin and the second bobbin in the second direction is uniform.

17. The transformer according to claim 1, wherein each of the upper core and the lower core includes a plurality of segment cores divided from each other.

18. The transformer according to claim 17, wherein the number of segment cores of the upper core and the number of segment cores of the lower core are different from each other.

19. The transformer according to claim 17, wherein the plurality of the segment cores have different sizes.

20. A display device, comprising:
the transformer described in claim 1; and
a circuit board having the transformer disposed thereon.
